(19) United States
(12) Patent Application Publication
(10) Pub. No.: US 2006/0252320 A1
(43) Pub. Date: Nov. 9, 2006

(54) Method of forming a PVC scrim fabric laminate having superior scuff and abrasion resistance

(75) Inventor: Dattatreya Ramesh Panse, Warwick, RI (US)

Correspondence Address: DOUGHERTY CLEMENTS, 1901 ROXBOROUGH ROAD, SUITE 300, CHARLOTTE, NC, 28211, US

(73) Assignee: Cooley, Incorporated

(21) Appl. No.: 11/123,799

(22) Filed: May 6, 2005

(51) Int. Cl. B32B 27/12; B32B 27/04

(52) U.S. Cl. 442/38; 442/43; 442/40; 442/49; 442/148

(57) ABSTRACT

The invention is a laminate and a method for making the laminate, where the laminate has good scuff resistance, good abrasion resistance, good low temperature properties, and excellent resistance to delamination. The laminate is constructed of a polyurethane primer coated scrim fabric that is laminated to a cast extruded compounded PVC film. The film composition is predominately polyvinyl chloride (PVC), a thermoplastic polyurethane polymer (TPU), and a polytetrafluoroethylene micronized wax. The method for forming the laminate is a) providing a compounded PVC and a primer coated scrim fabric; b) extruding the compounded PVC forming a cast extruded compounded PVC film; and c) laminating the compounded PVC film to the primer coated scrim fabric.

### BACKGROUND OF THE INVENTION

1. Field of the Invention

The invention relates generally to extrusion-coated fabrics, and more particularly to a PVC coated scrim having excellent scuff and abrasion resistance.

2. Prior Art

The prior art of laminates having scuff resistance includes the following patents. U.S. Pat. No. 6,066,601 to Steckel teaches a coating additive for a coating composition where the coating additive is a polytetrafluoroethylene. In Example 2 of column 20, lines 20-23, the coating composition contains a blend of polytetrafluoroethylene (PTFE) in a polyester resin/isocyanate curative powder coating formulation. The assignee, Lubrizol, manufactures micronized PTFE waxes.

U.S. Pat. No. 4,499,137 to O'Dell et al. teaches a scuff-resistant laminate. While the patent reads principally on polyethylene waxes, the specification states in column 4, lines 60-67, that there are times when other lubricants may be preferred, and specifically mentions micronized fluorocarbon polymers (tetrafluoroethylene) in fine particular size, such as SST-2 manufactured by Shamrock Chemicals, or Poly Fluo 190 by Micropowders.

U.S. Pat. No. 4,194,041 to Gore et al teaches a waterproof laminate. Gore discloses a PTFE sheet (column 9, line 41) and a polyurethane (column 4 lines 19-22). PVC is not taught.

U.S. Publication No. 2004/0116022 to Langley et al. teaches a durable waterproof composite sheet material. The fabric can be made from natural or synthetic fibers, such as nylon, polyester, acrylic, acetate, rayon, polyamides, polypropylene, polyethylene, flame-resistant fibers including PBI fibers, meta-aramides and para-aramides, such as Kevlar® and Nomex®, cotton, jute, hemp, ramie, and blends of one or more of the foregoing (column 3, lines 1-8). These materials have a coating of a polytetrafluoroethylene, as was described by Gore initially in U.S. Pat. No. 4,194,041. In the Background of the Invention, Langley et al. teach that PTFE can be combined with a thermoplastic polyurethane on a fabric to make a waterproof breathable material (paragraph 9, page 1). The TPU cited is Estane®, formerly a product of BF Goodrich, now produced by Noveon. Langley et al. further teach a durable waterproof composite sheet material. The fabric, paragraph 24, can be made from natural or synthetic fibers, such as nylon, polyester, acrylic, acetate, rayon, polyamides, polypropylene, polyethylene, flame-resistant fibers including PBI fibers, and meta-aramides and para-aramides such as Kevlar® and Nomex®, cottons, or jute.

U.S. Pat. No. 6,742,545 to Fisher et al. teaches a method of hose construction. In column 5 in lines 22-26, the thermal plastic material can be a polyolefin, polyester, a fluoropolymer, polyvinyl chloride, thermoplastic rubber, or polyurethane, or a polyamide such as Nylon. In column 6, lines 65-28, the list is further expanded to include EPDMs, NBRs, SBRs, and blends of them. These materials are all extruded.

A problem with laminates that are comprised of a flexible PVC thin film (e.g. less than 6 mils) laminated to an open scrim fabric is that the laminate exhibits poor scuff and abrasion resistance. Generally speaking, in order to achieve the desired flexibility the Durometer of the film is from 80 to 90 A. The laminate typically has an uneven profile causing wear to be exacerbated on the high spots, and the low Durometer aggravates the wear problem, as the friction is higher. Typically, high durometer (greater than 50 D) materials are used in applications where high scuff resistance is required but these materials are not flexible and do not posses good low temperature properties. The open scrims typically are woven from polyester or Nylon fibers because of their superior strength, and relatively modest cost for a relatively good weathering product. Unfortunately, polyester or Nylon fibers are also somewhat difficult to adhere to using a plasticized PVC, and combined with the previously enumerated problem of scuff and abrasion resistance, the laminate is subject to delaminating. Poor adhesion between film and fabric in turn manifests itself in inferior scuff resistance. What is needed is a laminate comprised of a PVC coated scrim that in addition to having good scuff resistance also has good abrasion resistance, good low temperature properties, and resistance to delamination.

### SUMMARY OF THE INVENTION

The invention is a laminate and a method for making the laminate, where the laminate has good scuff resistance, good abrasion resistance, good low temperature properties, and excellent resistance to delamination. The laminate is comprised of a scrim fabric having a polyurethane primer coating; and a cast extruded compounded PVC film, wherein said cast extruded compounded PVC film is comprised of a thermoplastic polyvinyl chloride polymer (PVC), a thermoplastic polyurethane polymer (TPU), and a fluoroethylene polymer. The fluoroethylene polymer is predominately polytetrafluoroethylene (PTFE), in the form of a micronized wax. The micronized PTFE can be cut or blended. The TPU is selected to have a low glass transition temperature, from about −10° C. to about −80° C., and to have excellent abrasion resistance. The TPU is preferably a thermoplastic elastomer comprised of an oligomeric block that is an aliphatic polyester or polyether. The scrim fabric is preferably an open scrim with pick count ranging from 9×9 to 22×22 picks per inch in warp and fill direction. The fabric can be either woven or knitted.

The method for forming the laminate is comprised of the steps of: a) providing a compounded PVC, where said compounded PVC comprises a thermoplastic polyvinyl chloride polymer (PVC), a thermoplastic polyurethane polymer (TPU), and a fluoroethylene polymer; b) extruding the compounded PVC forming a cast extruded compounded PVC film; and c) laminating the compounded PVC film to a scrim fabric having a polyurethane primer coating. The method for forming the laminate is preferably further comprised of the steps of; d) annealing the laminate in an oven to reduce curl and minimize anisotropic distortions in the laminate; e) cooling the laminate; and f) winding the annealed laminate into a roll and/or sheeting the annealed laminate. The scrim fabric having the polyurethane primer coating is preferably formed by dip coating the scrim fabric with a polyurethane primer coating; and then drying the polyurethane primer coating. The primer coating imparts dimensional stability to the scrim and chemical affinity between scrim fabric and the extruded compounded PVC film. The drying is not necessarily designed to fully cure the polyurethane primer coating, but merely to remove the volatile carrier (e.g., dispersing medium or solvent), leaving some reactive moieties on the scrim fabric. These reactive moieties can further improve the bond of the film to the scrim fabric. In the case where the polyurethane primer coating is an emulsion or dispersion in water, the preferred drying process is with an Infrared oven. The freshly primed scrim fabric can either be wound for use in the future, or, as a web, be in tandem with the extruder for lamination to the extruded compounded PVC film. Lamination can be effected by adhesively combining the extruded compounded PVC film with the primed coated scrim fabric or by, substantially simultaneously, casting the extruded compounded PVC film on a cold roll and, in a proximal nip, laminating the compounded PVC film to the primer coated scrim fabric. In the first case, where the lamination utilizes an adhesive, the adhesive extrudate is preferably a mixture comprised of PVC and TPU. In the latter case, generally a heavier coating of the cast compounded PVC extrudate is applied. In a variation on the method, the PVC film and adhesive extrudate are coextruded and laminated to the primer coated scrim fabric. In another variation on the method, the laminate is laminated with a second extruded compounded PVC film.

In the broadest sense, the invention is a laminate and a method for making the laminate, where the laminate is comprised of a scrim fabric having a primer coating and a cast extruded compounded PVC film, where the cast extruded compounded PVC film is comprised of PVC, TPU, and a fluoroethylene polymer. The method is particularly suitable for open scrim fabrics comprised of Nylon and polyester, as these materials are historically difficult to adhere.

### BRIEF DESCRIPTION OF THE DRAWINGS

The foregoing and other objects will become readily apparent by referring to the following detailed description and the appended drawings in which:

FIG. 1 is a perspective view of the invented laminate 10 of a primer coated scrim fabric and a compounded PVC film.

FIG. 2 is an exploded view of laminate 10 shown in FIG. 1, illustrating the primer coated scrim fabric and the compounded PVC film.

FIG. 3 is a perspective view of the primer coated scrim fabric of FIGS. 1 and 2.

FIG. 4 is an exploded diagrammatic view of the primer coated scrim fabric shown in FIG. 3, wherein the primer coating and scrim fabric are differentially shown.

FIG. 5 is a perspective view of the invented laminate 10′ of a primer coated scrim fabric, an adhesive and a compounded PVC film.

FIG. 6 is an exploded view of the laminate shown in FIG. 5, illustrating the primer coated scrim fabric, the adhesive and the compounded PVC film.

FIG. 7 is an exploded diagrammatic view of the laminate shown in FIG. 5, illustrating the scrim fabric, the primer coat, the adhesive, and the compounded PVC film.

### DETAILED DESCRIPTION

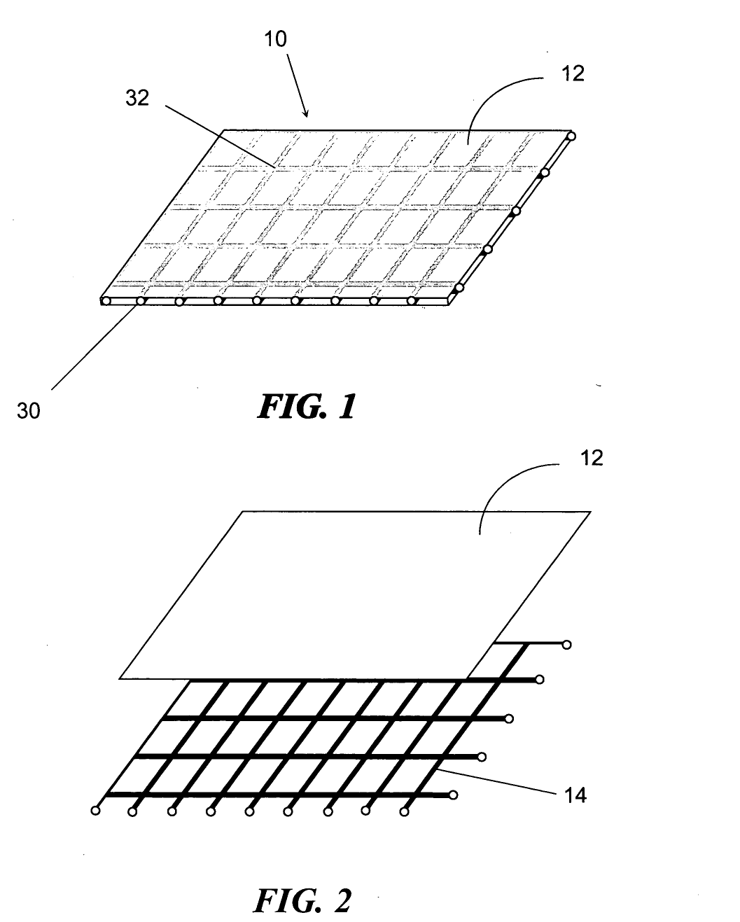

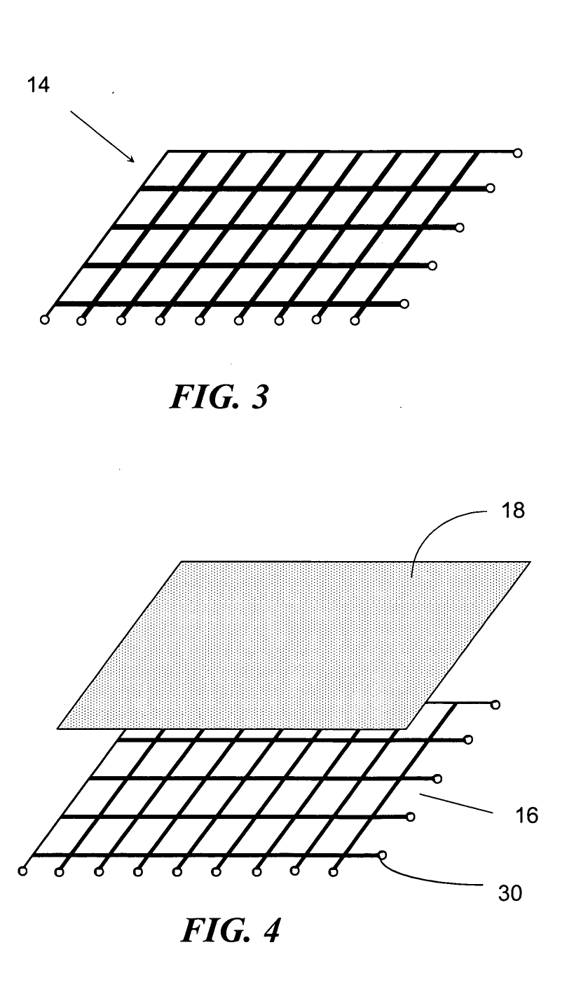

The invention is a laminate 10 and a method for making the laminate, where the laminate has good scuff resistance, good abrasion resistance, good low temperature properties, and excellent resistance to delamination. The laminate, shown in FIG. 1 and FIG. 2, is comprised of a primer coated scrim fabric 14 having a polyurethane primer coating, and a cast extruded compounded PVC film 12. The cast extruded compounded PVC film 12 is comprised of a thermoplastic polyvinyl chloride polymer (PVC), a thermoplastic polyurethane polymer (TPU), and a fluoroethylene polymer, which is substantially polytetrafluoroethylene (PTFE). The PTFE is in a micronized wax form. The TPU is selected to have a low glass transition temperature, from about −10° C. to about −80° C., and to have excellent abrasion resistance. Preferred TPU have hardness between 70 A-88 A. The TPU is preferably a thermoplastic elastomer comprised of an oligomeric component selected from the group consisting of polycaprolactone, polypropylene glycol, polypropylene glycol ethylene glycol, polytetramethylene glycol, polyisobutylene glycol, oligomeric aliphatic polyesters, oligomeric polyacrylic hydroxyalkyl esters, hydroxylated polybutadiene, and blends thereof. More preferably, the oligomeric component is selected from aliphatic polyesters and polyethers. Dow Chemical manufacturers a series of TPUs under the trade name of Pellethane® that have outstanding abrasion resistance and good low temperature flexibility. The 2102 series is a polyester (polycaprolactones) polyurethane having a Durometer Shore A hardness of 75 to 90. 2102-75 A has a glass transition temperature of −39° C., a hardness of 77 A, and a Taber Abrasion weight loss (ASTM D1044) of 20 mg/1000 cycles, using the coarse wheel, H-22. Having a slightly higher Durometer, 2102-80 A has a hardness of 84 A, a glass transition temperature of −40° C., and a Taber Abrasion weight loss of 10 mg/1000 cycles. The polyether series based on polytetramethylene glycol, 2103-70 A, has an even lower glass transition temperature −69° C., a hardness of 72 and an abrasion resistance of 3 mg/1000 cycles. Other commercially available TPU resins from Noveon sold under Estane trade name are also suitable. Examples of Estane grades suitable for this application are Estane 58213, Estane 54610, and Estane 58315. Polyester as well as Polyether based grades of TPU are suitable for this application. Suitable TPU have an abrasion resistance as measured by ASTM D1044 of less than or equal to 75 mg per 1000 cycles using the H-22 coarse wheel.

The PTFE is typically modified with polyethylene wax. A typical example is Lurizol® Lanco TF 1778. The PTFE enhances scratch resistance, resistance to scuffing, abrasion resistance, and improves anti-blocking properties. Another commercial grade of PTFE is Micro Powders Fluo series. These PTFE are high molecular weight, and provide long lasting properties, as they are very slow to bloom. In contrast, 3M's Dyneon® PTFE micropowders are low molecular weight polymers, and they are more prone to bloom. Dyneon® PTFE micropowders provide non-stick and anti-friction properties, but are less effective for providing scratch resistance, resistance to scuffing, and abrasion resistance. Other examples of micronized PTFE include Zonyl MP1300, Zonyl MP1600 from DuPont and Fluoro T-707 and T-807 from Shamrock Technologies. Preferred grade of micronized PTFE should have mean particle size less than 25 microns.

The PVC component of the compound is comprised of a suspension grade PVC resin, phthalate or adipate based monomeric plasticizers, flame retardants, antimicrobials, lubricants, heat stabilizers, mineral fillers, colorants and other common additives typically used in flexible PVC formulations. Examples of suspension grade PVC resin include OxyVinyls 240 and OxyVinyls 500 from Oxy Vinyls. Monomeric plasticizers can be linear or branched phthalate or adipate or a blend of adipates and phthalates. Examples of common plasticizers are DOP, DIDP, DPHP, DINP, 711P, L9P, DOA and DINA. Flame retardants can be selected to meet the char length and afterflame requirements in application requiring NFPA 701, ASTM D6413 or other similar flammability requirements. Antimony trioxide can be used as synergistic flame retardant with PVC. Other examples of flame retardants include phosphate plasticizers, zinc borate, ammonium molybdate, alumina trihydrate, magnesium hydroxide and various brominated compounds. Heat stabilizers suitable for the application include calcium zinc, barium zinc, cadmium zinc complexes. Examples include stabilizers sold under Mark® sold by Crompton Corporation, or Halstab® sold by OMG Corporation. Lubricants can be external and/or internal type and may consist of fatty esters, montan waxes, polyethylene waxes. Mineral fillers such as calcium carbonate, calcium sulfate can be used to reduce cost. Titanium dioxide can be used as a filler as well as colorant in applications requiring whiteness and good weathering properties.

The scrim fabric 16, as illustrated in FIG. 4, is an open scrim comprised of Nylon or polyester fibers 30 or a blend. Nylon is generally selected where greater flexibility and cost are not overriding considerations. The scrim fabric 16 is coated with a primer coating 18 to improve the bond to the compounded PVC. An excellent bond is formed using a polyurethane dispersion sold by Bayer Material Science, such as Dispercoll® 53. Dispercoll® 53 is an anionic aqueous dispersion of a high molecular weight polyurethane. When dried, Dispercoll® 53 imparts dimensional stability to the scrim fabric 16, as well as improves the bond between scrim fabric 16 and the compounded PVC film 12. The solids of the dispersion are approximately 40% by weight, and the viscosity is 50-600 centipoise. Typically, the solids are lowered to reduce pickup. Suitable coating methods include dip and squeeze, knife and rod (i.e., Meyer rod) coaters, fountain coaters, flooded gravure, foam coaters and roll coaters, such as reverse roll coaters. Foam coaters have the advantage that dilution water is not required, but the disadvantage that saturation is less penetrating. The thermal stability and the resistance to plasticizers and oil can be increased by the addition of a cross-linker, such as a water-emulsifiable polyisocyanate. An example of a suitable water-emulsifiable polyisocyanate is Desmodur® DN, which is an aliphatic polyisocyanate based on hexamethylene diisocyanate (HDI). Generally, 2-5% on a dry weight basis of the Dispercoll® 53 of the cross-linker is admixed with the anionic aqueous dispersion shortly before coating, as the HDI does limit the usable pot life of the primer coating. Additional cross-linker can be added to improve the bond with the compounded PVC.

The method for forming the laminate 10 is comprised of the steps of: a) providing a compounded PVC comprised of: a PVC, a TPU, and a fluoroethylene polymer that is substantially PTFE; b) extruding the compounded PVC forming a cast extruded compounded PVC film 12; and c) laminating the compounded PVC film 12 to a scrim fabric having a polyurethane primer coating 14. The compounded PVC is preferably compounded using a mix-extruder, wherein for every 100 parts of PVC there are 5 to 50 parts of TPU and 0.1 to 5.0 parts of PTFE. The PVC and the TPU are extrusion grade, and therefore are further comprised of the requisite processing aids, colorants, thermal and light stabilizers, plasticizers, oils, and fillers. The mix-extruder can be used to customize the compounded PVC by changing the ratio of the components, and adding other modifying components, such as additional processing aids, colorants, thermal and light stabilizers, plasticizers, oils, and fillers. In the method, the cast extruded compounded PVC film 12 is simultaneously formed and laminated with the primer coated scrim fabric, by extruding the compounded PVC through a die into a two roll nip, where the primer coated scrim fabric wraps a compression roll and the compounded PVC is in contact with an opposing steel roll. The steel roll has a finish that determines the surface of the film.

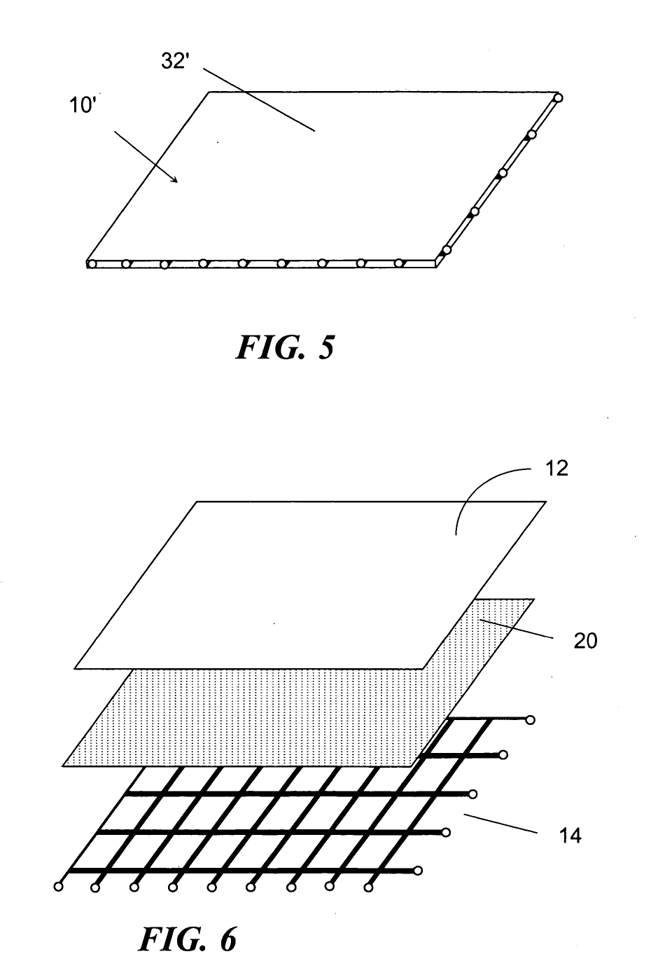

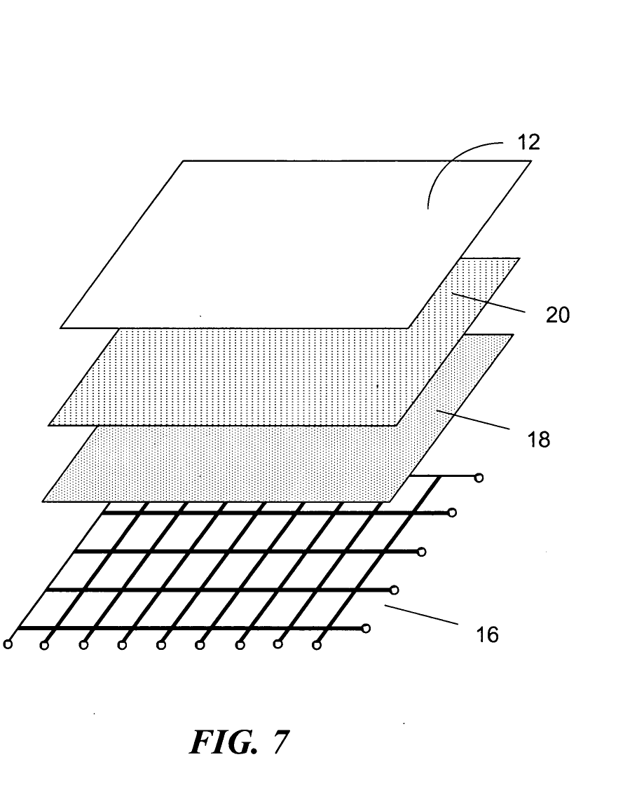

FIG. 6 illustrates a variation on the method, wherein the laminate 10′ is comprised of the compounded PVC film 12, the primer coated scrim 14 and an extruded adhesive 20. The extruded adhesive 20 bonds the film 12 to the scrim fabric 14. The adhesive is typically very similar to the compounded PVC, except without the fluoroethylene polymer—PTFE. PTFE is expensive and substantially not functional except on the surface of the compounded PVC film 12. A suitable extruded adhesive is comprised of an extrusion grade of PVC and an extrusion grade of TPU. Another potential advantage of using an extruded adhesive is that the finished laminate should have a more even profile for the same total weight of extruded material. The profile of the scrim 32′, as shown in FIG. 5, illustrates that the scrim protrudes less than the profile of the scrim 32, as shown in FIG. 1. FIG. 7 is an exploded diagrammatic view of the invented laminate 10′ shown in FIG. 5, illustrating the scrim fabric, the primer coat, the adhesive, and the compounded PVC film.

The extruded adhesive 20 and the compounded PVC film 12 can be co-extruded into the two roll nip; or alternatively the compounded PVC film 12 can be pre-cast and then the pre-cast film 12 and the primer coated scrim fabric 14 can be brought together at a nip containing the extruded adhesive 20.

Following lamination, the method is preferably further comprised of the steps of d) annealing the laminate in an oven to reduce curl and minimize anisotropic distortions in the laminate; e) cooling the laminate; and f) winding the annealed laminate into a roll and/or sheeting the annealed laminate.

In laminates where it is desired that both sides of the scrim fabric have a compounded PVC film, the scrim side of the laminate can be laminated with another layer of compounded PVC film using the method as previously set forth.

The primer coated scrim fabric 14, preferably freshly prepared using a method that imparts dimensional stability, will still have some primer coat that is not fully cured. When the primer coat 18 is not fully cured it is a more effective primer because when it comes into contact with the extrudate, either the compounded PVC film 12 or the extruded adhesive 20, the primer will become tacky with application of heat and have better wetting and therefore higher adhesion; and the latent cross-linker (i.e., polymeric isocyanate) will be available to bond with the extrudate. The primer coated scrim fabric 14 is prepared using a saturation coating process, such as dip and squeeze, and then drying in an IR oven to remove the volatile carrier. As previously taught, the primer is a high molecular weight polyurethane, and the cross-linker is a polyisocyanate. To minimize distortion of the scrim fabric 16, after the fibers 30 are woven into the scrim fabric, and while still on a loom, the scrim fabric 16 is saturation coated with the primer coating 18, dried and wound into a roll.

The following examples illustrate the formulations and properties of laminates:

| | Example 1 | Example 2 | Example 3 | Example 4 |
|---|---|---|---|---|
| | PHR | PHR | PHR | PHR |
| Ingredients | | | | |
| OXYVINYLS 500 RESIN | 100.000 | 100.000 | 100.000 | 100.000 |
| ANTIMONY TRIOXIDE | 8.300 | 14.000 | 14.000 | 14.000 |
| CALCIUM CARBONATE | 36.000 | 25.000 | 25.000 | 25.000 |
| ANTIMICROBIAL | 1.000 | 1.000 | 1.000 | 1.000 |
| EPOXIDIZED SOYABEAN OIL | 5.000 | 5.000 | 5.000 | 5.000 |
| PHTHALATE PLASTICIZER | 35.000 | 40.000 | 40.000 | 45.000 |
| PHOSPHATE PLASTICIZER | 15.000 | 5.000 | 5.000 | 5.000 |
| HEAT STABILIZER 1 | 2.200 | 3.000 | 3.000 | 3.000 |
| HEAT STABILIZER2 + LUBRICANT | 3.000 | 2.200 | 2.200 | 2.200 |
| BLEND | | | | |
| Alumina Trihydrate | | 20.000 | 20.000 | 20.000 |
| TPU | | 14.000 | 18.000 | |
| Micronized PTFE Wax | | 4.200 | | 5.000 |
| Test Results | | | | |
| Cycles To Exposed Fabric ASTM D3389 | 36 | 120 | 75 | 60 |
| Using H-18, 1000 gm load | | | | |
| Fingernail Mar Resistance | Poor | Good | Fair | Fair |

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim is expressed as a means or step for performing a specified function, it is intended that such claim be construed to cover the corresponding structure, material, or acts described in the specification and equivalents thereof, including both structural equivalents and equivalent structures.

What is claimed is:

1. A laminate, comprising: a primer coated scrim fabric; and a cast extruded compounded PVC film, wherein said cast extruded compounded PVC film is comprised of: a thermoplastic polyvinyl chloride polymer (PVC), a thermoplastic polyurethane polymer (TPU), and a fluoroethylene polymer.

2. The laminate, as claimed in claim 1, wherein said TPU has a glass transition temperature of from about −10° C. to about −80° C.

3. The laminate, as claimed in claim 1, wherein said PVC is an extrusion grade further comprised of the requisite processing aids, colorants, thermal and light stabilizers, plasticizers, oils, and fillers.

4. The laminate, as claimed in claim 1, wherein said fluoroethylene polymer is predominately polytetrafluoroethylene (PTFE).

5. The laminate, as claimed in claim 4, wherein said PTFE is a micronized wax.

6. The laminate, as claimed in claim 2, wherein said TPU is a polyurethane having an oligomeric component selected from the group consisting of polycaprolactone, polypropylene glycol, polypropylene glycol ethylene glycol, polytetramethylene glycol, polyisobutylene glycol, oligomeric aliphatic polyesters, oligomeric polyacrylic hydroxyalkyl esters, hydroxylated polybutadiene, and blends thereof.

7. The laminate, as claimed in claim 6, wherein said TPU is an extrusion grade of an aliphatic polyester or polyether urethane or a blend thereof.

8. The laminate, as claimed in claim 6, wherein said TPU has a Taber Abrasion Resistance, as defined by ASTM D1044, of less than 75 mg per 1000 cycles using the H-22 wheel.

9. The laminate according to claim 1, wherein said cast extruded compounded PVC film is further comprised of at least one modifying component selected from the group consisting of processing aids, colorants, thermal and light stabilizers, plasticizers, oils, and fillers.

10. The laminate, as claimed in claim 1, wherein said cast extruded compounded PVC film has, by weight, 5 to 50 parts of TPU per 100 parts of PVC.

11. The laminate, as claimed in claim 4, wherein said cast extruded compounded PVC film has, by weight, 0.1 to 5.0 parts of PTFE per 100 parts of PVC.

12. The laminate, as claimed in claim 1, wherein said primer coated scrim fabric is an open scrim fabric coated with a high molecular weight polyurethane.

13. The laminate, as claimed in claim 12, wherein said high molecular weight polyurethane has a polyisocyanate cross-linker.

14. The laminate, as claimed in claim 12, wherein said high molecular weight polyurethane is an anionic polyurethane dispersion.

15. The laminate, as claimed in claim 13, wherein said polyisocyanate cross-linker is based on hexamethylene diisocyanate.

16. The laminate, as claimed in claim 1, wherein said laminate is further comprised of an extruded adhesive.

17. The laminate, as claimed in claim 16, wherein said extruded adhesive is comprised of an extrusion grade of PVC and an extrusion grade of TPU.

18. A method for forming a laminate having superior scuff and abrasion resistance, said method comprising the steps of:
a) providing a compounded PVC, where said compounded PVC comprises a thermoplastic polyvinyl chloride polymer (PVC), a thermoplastic polyurethane polymer (TPU), and a fluoroethylene polymer;
b) extruding the compounded PVC forming a cast extruded compounded PVC film; and
c) laminating the compounded PVC film to a scrim fabric having a polyurethane primer coating.

19. The method, as claimed in claim 18, wherein said scrim fabric having the polyurethane primer coating is formed by steps comprised of:
i) dip coating a scrim fabric with a polyurethane primer coating;
ii) drying the polyurethane primer coating; and
iii) winding the primer coated scrim fabric.

20. The method, as claimed in claim 19, wherein said polyurethane primer coating is applied to the scrim fabric while it is being woven and is still on the loom.

21. The method, as claimed in claim 19, wherein said polyurethane primer coating is an aqueous dispersion of an anionic polyurethane and an aliphatic polyisocyanate.

22. The method, as claimed in claim 19, wherein said drying step is infrared drying.

23. The method, as claimed in claim 18, wherein said fluoroethylene polymer is predominately polytetrafluoroethylene (PTFE).

24. The method, as claimed in claim 23, wherein said PTFE is a micronized wax.

25. The method, as claimed in claim 24, wherein said compounded PVC is prepared by admixing the PVC, the TPU and the PTFE on a mix-extruder.

26. The method, as claimed in claim 18, wherein said extruding step is further comprised of:
extruding the compounded PVC through a die onto a two roll nip forming the compounded PVC film, where said die has a compression roll and a steel roll, and wherein said primer coated scrim fabric partially wraps the compression roll.

27. The method, as claimed in claim 18, wherein said method further comprises the step of:
d) annealing the laminate in an oven to reduce curl and minimize anisotropic distortions in the laminate.

28. The method, as claimed in claim 27, wherein said method further comprises the steps of:
e) cooling the laminate; and
f) winding the annealed laminate into a roll.

29. The method, as claimed in claim 18, wherein said extruding step further comprises:
co-extruding compounded PVC through a die onto a two roll nip forming the compounded PVC film, and extruding an adhesive between said film and said primer coated scrim fabric, where said die has a compression roll and a steel roll, and wherein said primer coated scrim fabric partially wraps the compression roll.

30. A method for forming a laminate having superior scuff and abrasion resistance, said method comprising the steps of:
a) providing a compounded PVC film, where said compounded PVC film is comprised of PVC, TPU, and a fluoroethylene polymer;
b) providing a scrim fabric with a polyurethane primer coating;
c) providing an extrudable adhesive comprised of PVC and TPU;
d) extruding the adhesive through a die onto a two roll nip to which is fed the compounded PVC film and the primer coated scrim fabric, where said die has a compression roll and a steel roll, and wherein said primer coated scrim fabric partially wraps the compression roll; and
e) laminating the compounded PVC film to the primer coated scrim fabric.
